(19) United States
(12) Patent Application Publication
(10) Pub. No.: US 2003/0043161 A1
(43) Pub. Date: Mar. 6, 2003

(54) Apparatus and method for bitmapping and synchronization

(75) Inventors: Jaw-Chih Tseng, Taichung (TW); Chung-Chieh Liu, Hsinchu (TW)

Correspondence Address: Ladas & Parry, 26 West 61st Street, New York, NY, 10023, US

(73) Assignee: SILICON INTEGRATED SYSTEMS CORP.

(21) Appl. No.: 09/947,803

(22) Filed: Sep. 6, 2001

(51) Int. Cl. G09G 5/00

(52) U.S. Cl. 345/581

(57) ABSTRACT

The present invention discloses an apparatus and method for bitmapping and synchronization. The present invention increases the serial number of a graphic command issued by a CPU. A page number of a display memory bitmapping to a graphic commands and a serial number of the graphic command are stored in a system memory connected to a CPU. The CPU directly accesses the display memory until the serial number corresponding to the page number stored in the page info equal to the page number of the graphic command issued currently by the CPU is less than the serial number of the graphic command executed currently by the graphic accelerator and the problem of data inconsistency could be neglected.

### BACKGROUND OF THE INVENTION

1. Field of the Invention

The present invention relates to an apparatus and method for bitmapping and synchronization, and particularly to an apparatus and method for improving the execution speed of a computer graphic system by using a CPU to directly access a display memory.

2. Description of the Related Art

FIG. 1 shows a well-known structure of a graphic system, comprising a CPU 11, a graphic accelerator 12, a display memory 13 and a command queue 14. The CPU 11 sends graphic commands to the command queue 14, which is a FIFO structure and could be embedded in a system memory or the graphic accelerator 12. The command queue 14 forwards the graphic commands into the graphic accelerator 12, which executes complicated graphic operations with an embedded hardware for drawing graphic functions. In the graphic process, the data of the display memory 13 is accessed by the CPU 13 and the graphic accelerator 12, and the data of the display memory 13 representing pixels are stored and shown in a screen. The CPU 11 not only sends graphic commands to the graphic accelerators 12 to finish the graphic operations, but also directly accesses the display memory 13. For example, in a 3D computer graphic processing, the CPU 12 usually has to directly access the attributes of pixels of the display memory 13, such as a color attribute.

FIG. 2 is a prior art schematic diagram concerning the correspondence of a command queue of the graphic accelerator to pages of the display memory. When sent from the CPU 11 to the graphic accelerator 12, the graphic commands will be stored in the command queue 31 of the graphic accelerator 12 and sequentially executed in a pipelined manner. The display memory 13 could be divided into several pages, and each graphic command in the command queue 31 bitmaps to one page of the display memory 13.

FIG. 3 is a prior art communication diagram among a CPU, graphic accelerator and display memory. After the CPU 11 sends a series of burstmode graphic commands to the graphic accelerator 12, the CPU 11 can not directly access the pixels of the display memory 13 to avoid data inconsistency before the burst-mode graphic commands ceases the access to the display memory. For example, a graphic command 21 in FIG. 3 is one of the burst-mode graphic commands sent from the CPU 11 to the graphic accelerator 12, and bitmaps to the page number 7 of the display memory 13. If the CPU 11 wishes to directly execute a graphic command 22 bitmapping to the page number 7 of the display memory 13 after the burst-mode graphic commands are sent, the CPU 11 has to wait for the graphic accelerator 12 executing a graphic command 23 corresponding to the burst-mode graphic command 21 having directly accessed the display memory 13. In most circumstances, the page number of the display memory 13 accessed by the CPU 11 is not necessarily equal to the page number bitmapping to the burst-mode graphic commands. Since if both of them are the same cannot be determined in prior art, the CPU 11 directly accesses the display memory 13 until the burst-mode commands in the command queue 31 are executed. As a result, the performance of the system is degraded.

### SUMMARY OF THE INVENTION

Accordingly, an object of the present invention is to eliminate the drawback that a CPU could directly access the display memory until all burst-mode graphic commands have been done by the graphic accelerator and therefore slowdown the performance of the system shown in prior art. To this end, the present invention provides an apparatus and method for bitmapping and synchronization. The present invention increases the original graphic command by a field representing a serial number, and stores the serial number of the graphic command into a system memory connected to the CPU indexed by the page number. When the CPU wants to access the display memory directly, whether the serial number of the graphic command sent from the CPU to the display memory is larger than the serial number of the graphic command stored in the system memory is further determined. If the answer is yes, it means that the two graphic commands have the property of data dependency, and the CPU can access the display memory directly until the graphic commands bitmapping to the same page have been executed. On the other hand, if the serial number of the graphic command accessed directly from the CPU to the display memory is less than the serial number of the graphic commands recorded in the system memory, the CPU could directly access the display memory and neglects the problem of data inconsistency.

The present invention discloses a method for bitmapping and synchronization, and comprises step (a) to (c). In step (a), a CPU issues a graphic command containing at least one page number bitmapping to a display memory to a graphic accelerator and assigns the graphic command a serial number. In step (b), the CPU updates serial numbers corresponding to the page number of the graphic command in a page info. In step (c), the CPU directly accesses the display memory until the serial number corresponding to the page number stored in the page info equal to the page number of the graphic command issued currently by the CPU is less than the serial number of the graphic command executed currently by the graphic accelerator.

The present invention discloses an apparatus for bitmapping and synchronization and comprises a CPU, a command queue, a graphic accelerator, a display memory and a system memory. The CPU is used to generate a plurality of graphic commands, said graphic commands including a page number bitmapping to a display memory and a serial number. The command queue is used to store the graphic commands sent from the CPU. The graphic accelerator executes the graphic commands and sends the serial number executed currently to the CPU. The display memory is connected to the CPU and graphic accelerator and divided into a plurality of pages. The system memory is connected to the CPU for storing the page number of the display memory bitrmapping to the graphic commands and the serial numbers of the graphic commands.

### BRIEF DESCRIPTION OF THE DRAWINGS

The invention will be described according to the appended drawings in which:

FIG. 1 is a structure of a prior art graphic system;

FIG. 2 is a prior art schematic diagram concerning the correspondence between a command queue of the graphic accelerator and the display memory;

FIG. 3 is a prior art communication diagram between a CPU, graphic accelerator and display memory;

FIG. 4 is a structural diagram of the graphic system according to the present invention;

FIG. 5 is a corresponding diagram between a command queue of the graphic accelerator and the display memory according to the present invention;

FIG. 6 is a communication diagram between a CPU, graphic accelerator and display memory according to the present invention;

FIG. 7 is a flow chart according to the present invention; and

FIG. 8 shows an embodiment of the present invention.

### PREFERRED EMBODIMENT OF THE PRESENT INVENTION

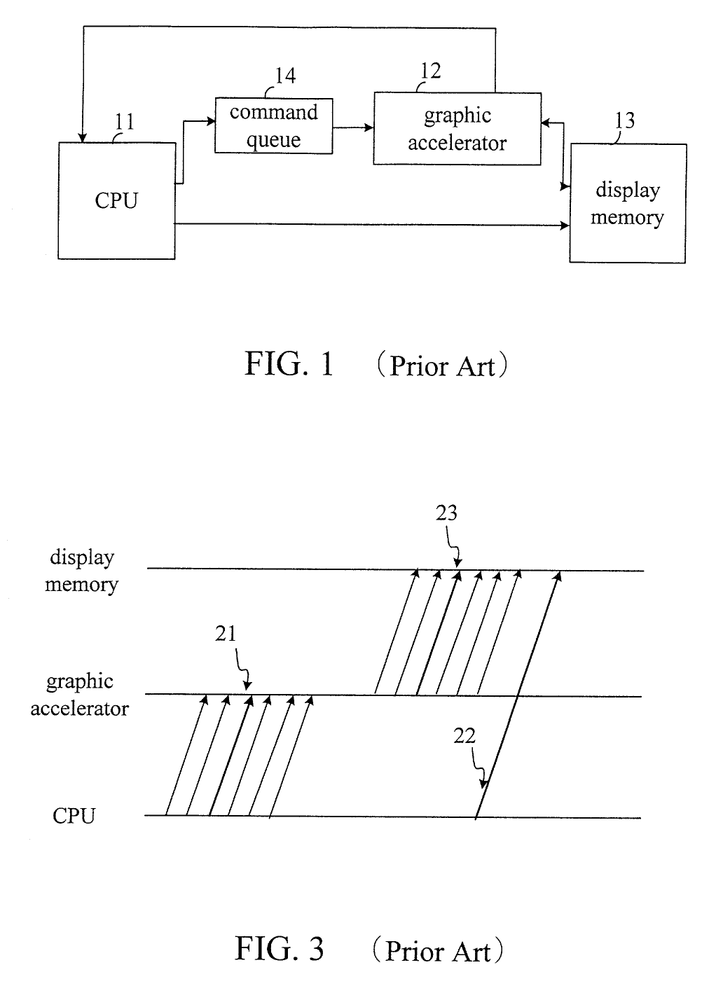

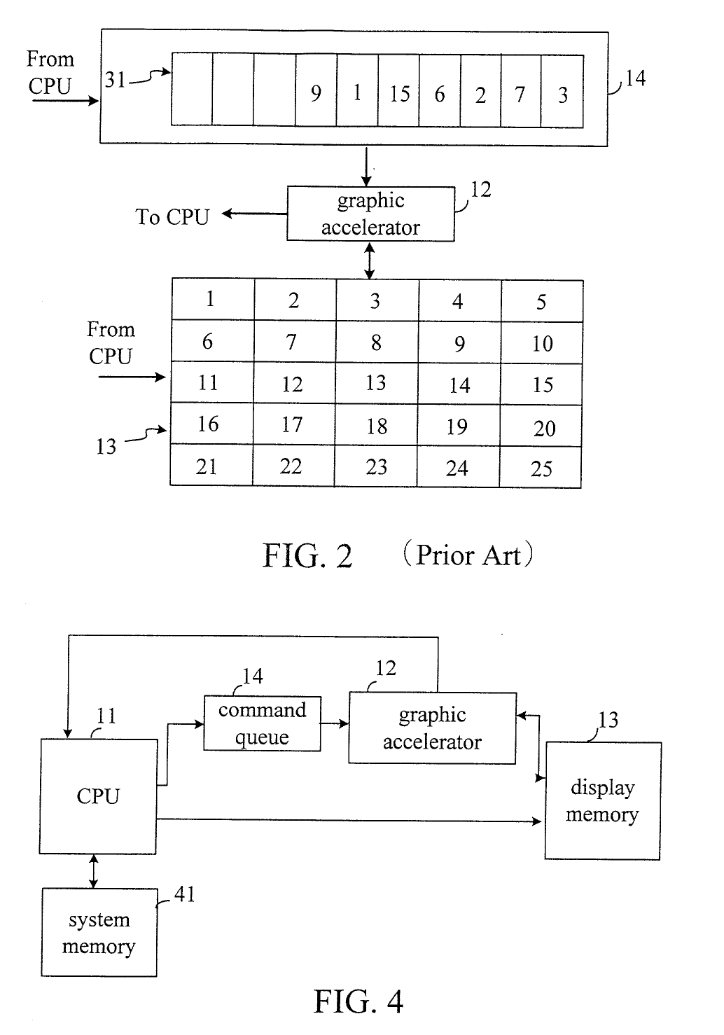

FIG. 4 is a structural diagram of the graphic system according to the present invention. The difference from FIG. 1 is that the structure in FIG. 4 further comprises a system memory 41 for storing a control program and a page info. The page info records page number of the display memory 13 that the graphic commands from the CPU 11 bitmaps and a serial number of the graphic command. The system memory 41 could stand alone outside the CPU 11 or be embedded inside the CPU 11, and the present invention does not limit it.

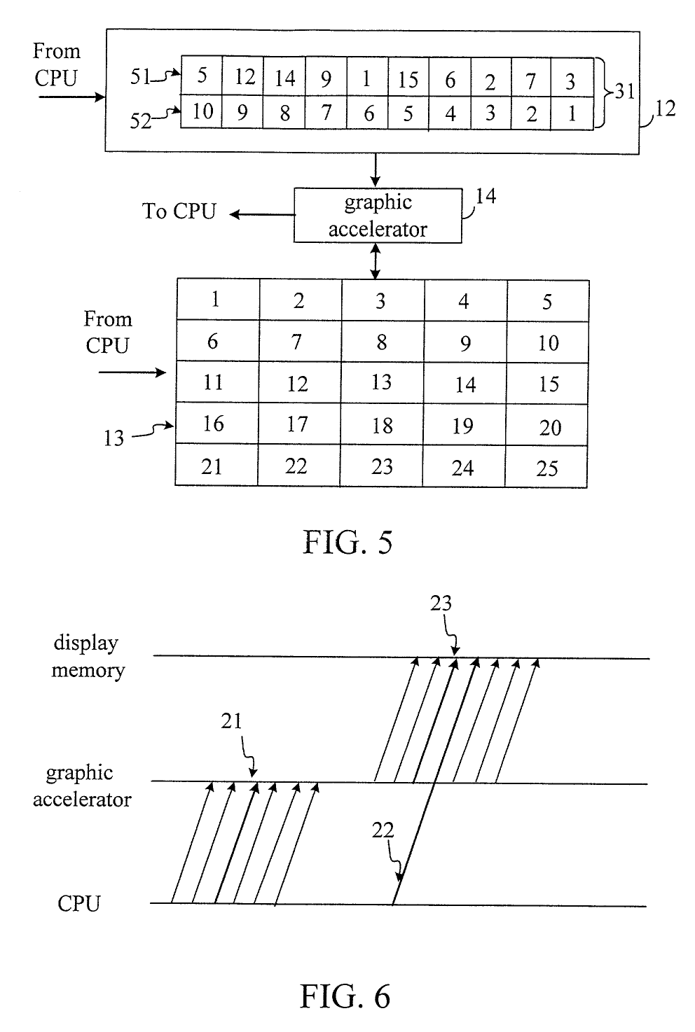

FIG. 5 is a corresponding diagram between a command queue 14, the graphic accelerator 12 and the display memory 13 according to the present invention. The graphic command packets 31 sent from the CPU 11 to the command queue 14 comprises at least two fields. The two fields are a field 51 indicating the page number of the display memory 13 bitmapping to the graphic command and a field 52 indicating the serial number of the graphic command. These two fields of the graphic commands are also stored in the page info of the system memory 41, and the serial number of the graphic commands is generated in an increasing mode.

FIG. 6 is a communication diagram between a CPU, graphic accelerator and display memory according to the present invention. After the graphic accelerator 12 has executed the graphic command 23, the CPU 11 can execute a graphic command 22 and directly access the display memory 13. The difference from the prior art is that the fields 51 and 52 of the graphic commands sent by the CPU 11 are recorded in the system memory 41. Therefore, the CPU 11 will know all the page number that the graphic commands in the command queue 31 bitmaps and the serial number of all graphic commands. Before the CPU 11 directly accesses the display memory 13, whether the page number being accessed is equal to any page number of graphic commands in the command queue 31 is first determined. If the answer is yes, it means that two graphic commands simultaneously access the same page in the display memory 13. Meanwhile, the CPU 11 compares the serial numbers of the two graphic commands and executes the graphic command having a smaller page number earlier than the one having a larger page number. The comparison could be expressed by equation (1). If the condition of equation (1) is satisfied, it means that the serial number of the graphic command that the CPU II directly accesses is less than the serial number of the graphic command stored in the system memory 41 and corresponds to the same page of the display memory. Therefore, the CPU 11 can directly access the display memory 13 by sending graphic commands.

[(k−j)+N]mod N>[(k−i)+N]mod N (1)

wherein k is the number of graphic commands stored in the command queue 31; j is the serial number of the graphic command bitmapping to the same page number; i is the serial number of the graphic command for accessing the display memory by the CPU; N is the maximal serial number. For example, N is equal to 256 if the serial number has 8 bits in width, and the symbol “mod” represents an abbreviation of modulo.

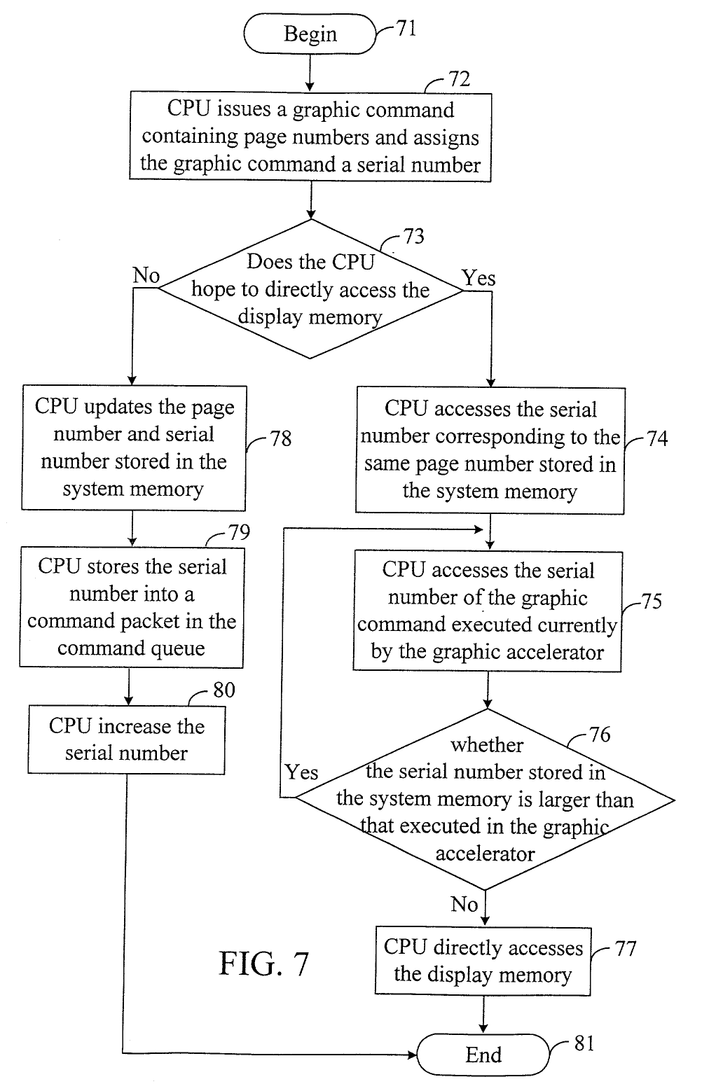

FIG. 7 is a flow chart according to the present invention. In step 71, the present invention starts. In step 72, the CPU issues a graphic command containing page numbers and assigns the graphic command a serial number. In step 73, determine if the CPU hope to directly access the display memory. If the answer is yes, then enter step 74; otherwise enter step 78. In step 74, the CPU accesses the serial number corresponding to the same page number stored in the system memory. In step 75, the CPU accesses the serial number of the graphic command executed currently by the graphic accelerator. In step 76, determine if the serial number stored in the system memory is larger than that executed in the graphic accelerator. If the answer is yes, then enter step 75; otherwise enter step 77. In step 77, the CPU directly accesses the display memory. In step 78, the CPU updates the page number and serial number stored in the system memory. In step 79, the CPU stores the serial number into a command packet of the command queue. In step 80, the CPU increase the serial number. After the steps 77 and 80 are executed, the process enters step 81 and finishes. Unlike the prior art, it is not necessary for the present invention to wait for all graphic commands in the command queue 14 having been executed before the CPU 11 directly accesses the display memory 13. The CPU 11 of the present invention just needs to wait for the graphic command in the command queue bitmapping to the same page having been executed before directly accessimg the display memory 13. By the above description, the CPU 11 can save much waiting time, and the performance of total system could be raised.

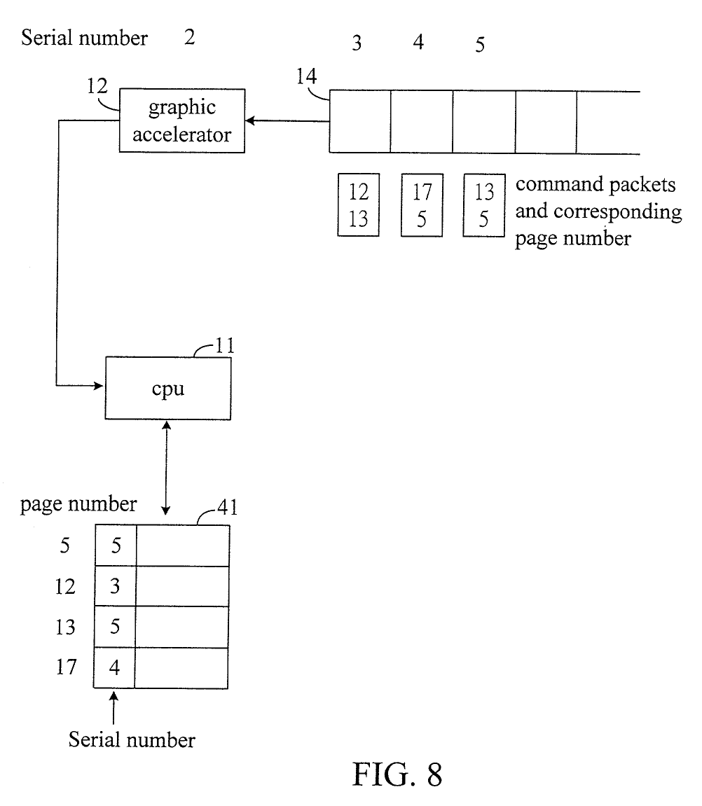

FIG. 8 shows an embodiment of the present invention. In FIG. 8, there are at least three graphic command packets whose serial numbers are 3, 4 and 5 in the command queue 14, and the graphic accelerator 12 is currently executing a graphic command whose serial number is 2. By the way, the CPU 11 continuously updates the serial number corresponding to the page number of the graphic command issued by the CPU. A page info is stored in a system memory 41, and records page numbers bitmapping to the display memory 13 and the serial number of the graphic command corresponding to the recorded page number. For example, the graphic command with a serial number 3 stored in the command queue 14 corresponds to page numbers 12 and 13, the graphic command with a serial number 4 stored in the command queue 14 corresponds to page numbers 17 and 5, and the graphic command with a serial number 5 stored in the command queue 14 corresponds to page numbers 13 and 5. The page into is updated by the CPU 11 according to the above sequences. For example, the page number 5 stored in the system memory 41 corresponds to the serial number 5 since the graphic command with serial number 5 accesses to the page number 5 of the display memory 13 lastly, and the page number 12 stored in the system memory 41 corresponds to serial number 3 since the graphic command with serial number 3 accesses to the page number 12 of the display memory 13 lastly. When the CPU 11 intends to directly accesses the page number 12 of the display memory 13, the CPU 11 first examines the serial number corresponding to page number 12 stored in the page info. In this embodiment, the corresponding serial number is 3. Therefore, the CPU 11 must wait for the graphic command with serial number 3 to be executed, and then forestalls the graphic command with serial number 5 to directly access the display memory 13.

The above-described embodiments of the present invention are intended to be illustrated only. Numerous alternative embodiments may be devised by those skilled in the art without departing from the scope of the following claims.

What is claimed is:

1. A method for bitmapping and synchronization, applied in a computer graphic process, comprising the following steps:
(a) a CPU issuing a graphic command containing at least one page number bitmapping to a display memory to a graphic accelerator and assigning the graphic command a serial number;
(b) the CPU updating serial numbers corresponding to the page number of the graphic command in a page info; and
(c) the CPU directly accessing the display memory until the serial number corresponding to the page number of the graphic command issued currently by the CPU stored in the page info is less than the serial number of the graphic command executed currently by the graphic accelerator.

2. The method of claim 1, wherein the condition that the CPU could directly access the display memory is represented as [(k−j)+N] mod N>[(k−i)+N] mod N; wherein k is the number of graphic commands stored in a command queue; j is the serial number of the graphic command stored in the command queue bitmapping to the same page number of the graphic command issued by the CPU; i is the serial number of the graphic command for accessing the display memory by the CPU; N is the maximal serial number.

3. An apparatus for bitmapping and synchronization, comprising:
a CPU for generating a plurality of graphic commands, said graphic commands including at least one page number bitmapping to a display memory and a serial number;
a command queue for storing the graphic commands sent from the CPU;
a graphic accelerator for executing graphic commands and sending the serial number of the graphic command currently executed to the CPU;
a display memory connected to said CPU and graphic accelerator and divided into a plurality of pages; and
a system memory connected to said CPU for storing the newest serial number corresponding to the page number of the graphic command issued by the CPU.

4. The apparatus of claim 3, wherein the command queue is embedded in the graphic accelerator.
